(19) United States
(12) Patent Application Publication
(10) Pub. No.: US 2023/0009586 A1
(43) Pub. Date: Jan. 12, 2023

(54) OPTIMIZATION OF THE AXLE DISTRIBUTION STRATEGY IN A BEV

(71) Applicant: AUDI AG, Ingolstadt (DE)

(72) Inventors: Boris Blasinski, Gaimersheim (DE); Andrè Föllner, Calau (DE)

(21) Appl. No.: 17/858,753

(22) Filed: Jul. 6, 2022

(30) Foreign Application Priority Data
Jul. 7, 2021 (DE) 102021117561.5

(51) Int. Cl. B60L 15/32; B60L 15/20

(52) U.S. Cl. CPC B60L 15/32; B60L 15/2045; B60L 2240/423; B60L 50/60

(57) ABSTRACT

Methods and devices are provided for online optimization of the axle distribution strategy in a battery electric vehicle (BEV) with more than one drive axle.

### BACKGROUND

### Technical Field

Embodiments of the present invention relate to a method and a device for online optimization of the axle distribution strategy in a battery electric vehicle (BEV) with more than one drive axle.

### Description of the Related Art

The axle distribution strategy in a BEV with more than one drive axle aims to operate both drive machines during driving in such a way that the power losses are minimized. The aim here is to achieve the greatest possible range for the vehicle. For this purpose, maps are stored in the software in which the power losses for each possible operating point are stored statically. An optimizer then calculates the power losses for different torque distributions on the drive machines and determines the distribution where the lowest losses are to be expected.

It is very elaborate to store all dependencies in static maps. At least the dependencies of the e-machine temperature and the current voltage must be mapped. Due to the properties of the various e-machine concepts (machine constants), the power loss maps for each derivative must be generated offline and distributed per application. This is error-prone and requires a certain compromise between effort and benefit, which ultimately results in a loss of efficiency in the drive.

DE 10 2015 110 414 A1 discloses a method for controlling a hybrid powertrain, which comprises the following steps: receiving a torque request; determining a plurality of possible motor torques of the first and second electric machines capable of achieving the torque requested; determining system power losses of the powertrain for all possible motor torques for the first and second electric machines capable of achieving the torque requested; determining a lowest power loss of the system power losses determined for the plurality of possible motor torques of the first and second electric machines; determining a first operating torque for the first electric machine and a second operating torque for the second electric machine that correspond to the lowest power loss; and commanding the first electric machine to generate the first operating torque and commanding the second electric machine to generate the second operating torque in order to achieve the torque requested while minimizing the system power losses.

IN 2017 41042910 A discloses a method for torque distribution of an electric vehicle. The method comprises determining torque demand based on at least one of accelerator pedal position and velocity of the electric vehicle, and is characterized by determining a plurality of torque pairs that correspond to the torque demand, calculating total power loss, by the controller, for each of the plurality of torque pairs, the total power loss being calculated based on at least one of a rear e-axle component loss, and a front e-axle component loss, selecting a torque pair of the plurality of torque pairs by the controller, the selected torque pair corresponding to the minimum of the total power loss calculated for each of the multiple torque pairs, and supplying power to a first electric motor and a second electric motor, by the battery, based on the selected torque pair.

CN 212332359 U relates to a driving system of an electric vehicle and a control method thereof. The driving system comprises a front wheel motor and a rear wheel motor which are the same in specification. An output shaft of the front wheel motor is operatively connected with a front wheel driving axle of the electric automobile through the front wheel speed reducer; an output shaft of the rear wheel motor is operatively connected to a rear wheel drive axle of the electric vehicle via the rear wheel speed reducer, and the front wheel speed reducer has a transmission ratio different from that of the rear wheel speed reducer.

Against this background, embodiments of the invention provide devices and methods with which the torque distribution in a battery electric vehicle (BEV) with more than one drive axle can be optimized in real time, efficiently and with little effort, and thus the total power loss of the drive system can be minimized.

### BRIEF SUMMARY

Some embodiments include a method for optimizing the torque distribution in a drive system of a battery electric vehicle (BEV), which has more than one drive axle and a number n of electric machines driving the drive axles. A control unit for the torque distribution calculates the power loss of each e-machine i and determines a minimum of the total power loss P_{V,ges} of the drive system, and then controls the e-machines i so that they jointly M_{Anf} provide a torque requested, each electric machine i generating the torque Mᵢ determined for the minimum of the total power loss P_{V,ges} and assigned to it.

### DETAILED DESCRIPTION

According to some embodiments of the invention, when there is a torque request M_{Anf}, a value P_{V0,i} for the current drag losses and a factor K_{Phi,i} for the current operating point are transmitted to the control unit from each of the electric machines i, and the control unit calculates the power loss of each electric machine i according to:

P_{V,i}=P_{V0,i}+K_{Phi,i}*Mᵢ²,

calculates the total power loss of the drive system according to:

P_{V,ges}=Σᵢ₌₁ⁿP_{V,i},

and determines the minimum of the total power loss by varying the torque Mᵢ of the individual e-machines i, where applies:

M_{Anf}=Σᵢ₌₁ⁿMᵢ.

The optimal distribution is determined by an online calculation of the power losses of the various torque distributions on the axles. For this purpose, a value for the current “drag losses” (P_{V0}) and a factor for the current operating point (K_{Phi}) are transmitted from each drive machine to the axis distribution strategy, with the help of which the losses can be calculated at runtime. Here, online means that the values are determined at runtime in real time without the use of characteristic maps or characteristic curves or other static data.

The calculation takes into account that the power loss of an e-machine follows a simple quadratic equation depending on its current operating point and its machine constants. P_{V0} represents the power loss at “no load,” K_{Phi} is the factor for the current operating point, which the power electronics of the respective e-machine calculates based on its machine constants and the current load point. It is equal to the difference between the total power loss and the no-load power loss divided by the square of the actual torque. The two values P_{V0} and K_{Phi} are each formed by the power electronics of the respective e-machine, since the information about machine constants, current speed, current temperature, current voltage and air gap is available here anyway because it is required for the operation of the e-machine. The two values P_{V0} and K_{Phi} also include the speed, rotor temperature, stator temperature, current operating voltage and the resistance of the respective e-machine caused by the air gap.

With this information, the control unit can calculate the total losses for different torque distributions online and determine a minimum, with different torques Mᵢ being tried out in an optimizer. The lowest total loss can be found by summing up all machines. The torque that led to the lowest total loss is output as the target torque for the respective e-machine. In one embodiment of the method the minimum of the total power loss P_{V,ges} of the drive system is determined in real time.

In one embodiment of the method, the number of driven axles is 2.

In one embodiment of the method, the number n of e-machines is 2. In another embodiment of the method, the number n of e-machines is 4, i.e., each wheel of the vehicle is driven by an assigned e-machine (all-wheel drive).

Some embodiments of the invention also relate to a drive system for a battery electric vehicle (BEV), which has more than one drive axle and a number n of e-machines driving the drive axles, and a control unit for torque distribution, which is set up to calculate the power loss of each of the e-machines, and, when there is a torque request M_{Anf}, to determine a minimum of the associated total power loss P_{V,ges} of the drive system, and then to control the e-machines in such a way that they jointly M_{Anf} provide the requested torque, each e-machine i generating in each case the torque Mᵢ determined for the minimum of the total power loss P_{V,ges} and assigned to it, characterized in that, when there is a torque request M_{Anf}, the e-machines i transmit in each case a value P_{V0,i} for the current drag losses and a factor K_{Phi,i} for the current operating point to the control unit, and the control unit calculates the power loss of each e-machine i according to P_{V,i}=P_{V0,1}+K_{Phi,i}*Mᵢ²,

In one embodiment, the control unit of the drive system comprises an optimizer for determining the minimum of the total power loss P_{V,ges} in real time.

In one embodiment of the drive system, the number of driven axles is 2.

In one embodiment of the drive system, the number n of e-machines is 2. In another embodiment, the number n of e-machines is 4.

By the online optimization, the torque distribution to the drive axles (axle distribution strategy) can be implemented using standard software, and there is no need to develop an application for each drive variant. This approach is less error-prone and no concessions have to be made that could have a negative impact on efficiency. The online optimization achieves more precise results, since not all dependencies can be mapped in any level of detail with the static approach.

German patent application no. 10 2021 117561.5, filed Jul. 7, 2021, to which this application claims priority, is hereby incorporated herein by reference, in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for optimizing torque distribution in a drive system of a battery electric vehicle, which has more than one drive axle and a number n of e-machines driving the drive axles, the method comprising:
using a control unit to calculate a power loss of each e-machine i for the torque distribution and determine a minimum of a total power loss P_{V,ges} of the drive system;
using the control unit to control the e-machines i so that they jointly M_{Anf} provide a torque requested, each e-machine i generating in each case a torque Mᵢ determined for the minimum of the total power loss P_{V,ges} and assigned to it;
wherein, when there is a torque request M_{Anf}, in each case a value P_{V0,i} for current drag losses and a factor K_{Phi,i} for a current operating point is transmitted to the control unit from each of the e-machines i, and the control unit calculates the power loss of each e-machine i according to:
P_{V,i}=P_{V0,i}+K_{Phi,i}*Mᵢ²,
the total power loss of the drive system calculated according to:
P_{V,ges}=Σᵢ₌₁ⁿP_{V,i}.
and the minimum of the total power loss is determined by varying the torques Mᵢ of the individual electric machines i, according to:
M_{Anf}=Σᵢ₌₁ⁿMᵢ.

2. The method according to claim 1, wherein a number of driven axles is two.

3. The method according to claim 2, wherein the number n of e-machines is two.

4. The method according to claim 2, wherein the number n of e-machines is four.

5. The method according to claim 1, wherein the determination of the minimum of the total power loss P_{V,ges} of the drive system takes place in real time.

6. A drive system of a battery electric vehicle, comprising:
more than one drive axle;
a number n of e-machines driving the drive axles; and
a control unit for torque distribution, which is set up to calculate a power loss of each of the e-machines, and, when there is a torque request M_{Anf}, to determine a minimum of an associated total power loss P_{V,ges} of the drive system, and then to control the e-machines in such a way that they jointly provide the requested torque M_{Anf}, each electric machine i generating a torque Mᵢ determined for the minimum of the total power loss P_{V,ges} and assigned to it;
wherein, when there is a torque request M_{Anf}, the e-machines i in each case transmit a value P_{V0,i} for the current drag losses and a factor K_{Phi,i} for the current operating point to the control unit, and the control unit calculates the power loss of each e-machine according to P_{V,i}=P_{V0,i} K_{Phi,i}*Mᵢ².

7. The drive system according to claim 6, wherein the number of driven axles is two.

8. The drive system according to claim 7, wherein the number n of e-machines is two.

9. The drive system according to claim 7, wherein the number n of e-machines is four.

10. The drive system according to claim 5, wherein the control unit comprises an optimizer for determining the minimum of the total power loss P_{V,ges} in real time.
